(19) United States
(12) Patent Application Publication
(10) Pub. No.: US 2024/0049906 A1
(43) Pub. Date: Feb. 15, 2024

(54) FROTHING HEAD FOR HEATING AND WHIPPING MILK

(71) Applicant: LUIGI LAVAZZA S.P.A., Torino (IT)

(72) Inventors: Gabriele MOLINARO, Torino (IT); Gabriele Luciano PICONE, Torino (IT); Jelmer Jeroen KUIPER, Enschede (NL); Andreas Jacobus Louis NIJSEN, Enschede (NL); Hedzer Michiel Adriaan VAN DER KAMP, Zutphen (NL)

(73) Assignee: LUIGI LAVAZZA S.P.A., Torino (IT)

(21) Appl. No.: 18/270,803

(22) PCT Filed: Jan. 3, 2022
(86) PCT No.: PCT/IB2022/050011

§ 371 Date: Jul. 3, 2023

(30) Foreign Application Priority Data
Jan. 4, 2021 (IT) 102021000000026

(51) Int. Cl. A47J 31/44; A47J 31/46; A47J 31/41

(52) U.S. Cl. CPC A47J 31/4485; A47J 31/468; A47J 31/41

(57) ABSTRACT

A frothing head for heating and whipping milk is provided. The frothing head has a mixing chamber, a restriction duct extending from the mixing chamber, a frothing chamber arranged at one end of the restriction duct, a distribution duct, an air suction duct leading into the mixing chamber, and a milk suction duct leading into the mixing chamber. The frothing chamber is disc-shaped, and the restriction duct leads tangentially into the frothing chamber. The distribution duct extends axially from a center of a bottom surface of the frothing chamber and has an upper portion and a lower portion having a greater diameter than the upper portion.

### CROSS-REFERENCE TO RELATED APPLICATIONS

This application is a National Phase Application of PCT International Application No. PCT/IB2022/050011, having an International Filing Date of Jan. 3, 2022, claiming priority to Italian Patent Application No. 102021000000026, filed Jan. 4, 2021 each of which is hereby incorporated by reference in its entirety.

### FIELD OF THE INVENTION

This invention relates in general to devices for heating and whipping milk, which devices may be used for preparing a hot beverage such as a cappuccino, warm milk, and the like.

### BACKGROUND OF THE INVENTION

Devices for preparing a creamy air/milk/steam emulsion based on the principle of a steamdriven jet pump are known. In such devices, a steam jet produced by a nozzle creates, by the Venturi effect, a negative pressure in a suction chamber located downstream of the nozzle, the negative pressure drawing air and milk into the suction chamber through respective inlets connected to said chamber. Steam, milk and air mixed in the suction chamber then flow into a subsequent chamber where an emulsion is produced.

In these known solutions, the configuration described above is designed as an accessory or frothing head which is mounted to a steam supply nozzle of a machine, for example a machine for the preparation of coffee or a machine specifically for the preparation of frothed milk.

### SUMMARY OF THE INVENTION

The object of this invention is to provide a frothing head capable of producing particularly compact and homogenous froth.

This and other objects are achieved according to the invention by a frothing head for heating and whipping milk, which frothing head comprises a head body which may be sealingly mounted to a supply interface of a machine for the preparation of hot beverages, in said head body there being formed:
a mixing chamber arranged downstream of a steam supply nozzle, the mixing chamber comprising a proximal end configured to define an annular gap around an end of the steam supply nozzle, and a convergent distal end,
a restriction duct extending forward from the distal end of the mixing chamber,
a frothing chamber arranged at a distal end of the restriction duct,
a distribution duct extending from the frothing chamber,
an air suction duct that has an inlet end which is connectable to an air supply, and an outlet end leading into the proximal end of the mixing chamber,
a milk suction duct that has an inlet end which is connectable to a milk reservoir, and an outlet end leading into the proximal end of the mixing chamber,
wherein said mixing chamber, restriction duct and frothing chamber are configured to cooperate with the steam supply nozzle to form a jet pump, in which a steam jet is capable of drawing air and milk into the mixing chamber through the air suction duct and the milk suction duct, respectively, the frothing chamber homogenizing a mixture of steam, air and milk produced in the mixing chamber,
wherein the frothing chamber is disc-shaped and comprises a bottom surface, a top surface and a round side surface extending between the bottom surface and the top surface, wherein the distal end of the restriction duct leads tangentially into the frothing chamber, at the side surface of the frothing chamber and at an intermediate height between the bottom surface and the top surface,
wherein the distribution duct extends axially from the center of the bottom surface of the frothing chamber, and comprises an upper portion and a lower portion having a greater diameter than the upper portion.

The inventors have discovered that the particular geometry of the frothing chamber and of the distribution duct makes it possible to obtain a particularly compact and homogenous milk froth.

### BRIEF DESCRIPTION OF THE FIGURES

Further features and advantages of the invention will become clear from the detailed description that follows, given purely by way of non-limiting example and with reference to the accompanying drawings, in which:

FIG. 1 is a perspective view of a frothing head for heating and whipping milk according to this invention, which frothing head is mounted to a supply interface of a machine for the preparation of hot beverages,

FIG. 2 is a perspective view of the frothing head in FIG. 1, separated from the supply interface,

FIG. 3 is a sectional view of the frothing head in FIG. 1,

FIG. 4 is a cross-sectional perspective view of the frothing head in FIG. 1,

FIG. 5 is a further sectional view of the frothing head in FIG. 1,

FIG. 6 is a further perspective view of the frothing head in FIG. 1,

FIGS. 7 and 8 are perspective views which show the frothing head in a cleaning position,

FIG. 9 is a sectional view of a second embodiment of the frothing head according to the invention, and

FIG. 10 is a sectional view along an axis of a distribution duct of the frothing head in FIG. 9.

### DETAILED DESCRIPTION

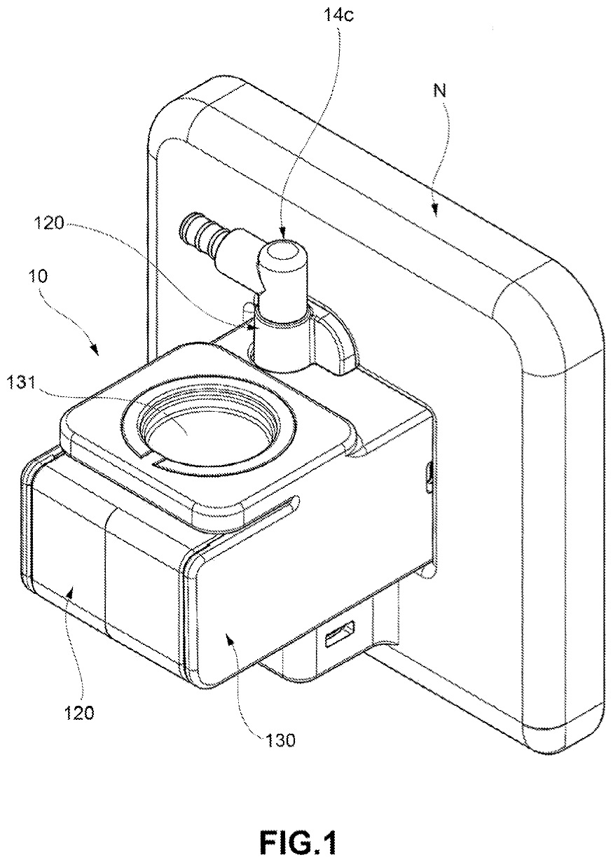

A frothing head according to this invention for heating and whipping a quantity of milk contained in a reservoir is shown collectively in FIGS. 1 to 3. This frothing head, indicated as a whole by reference sign 10, is configured to be sealingly mounted to a supply interface N of a machine M for the preparation of hot beverages. This machine may be, for example, a machine for the preparation of coffee or a machine specifically for the preparation of frothed milk, which machines typically comprise a hydraulic system for generating steam from water drawn from a reservoir and distributing this steam for its intended purposes.

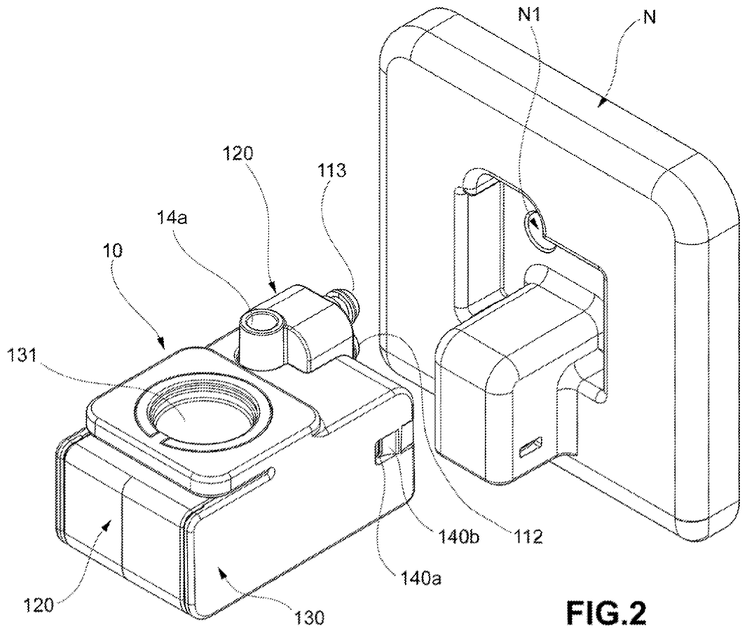

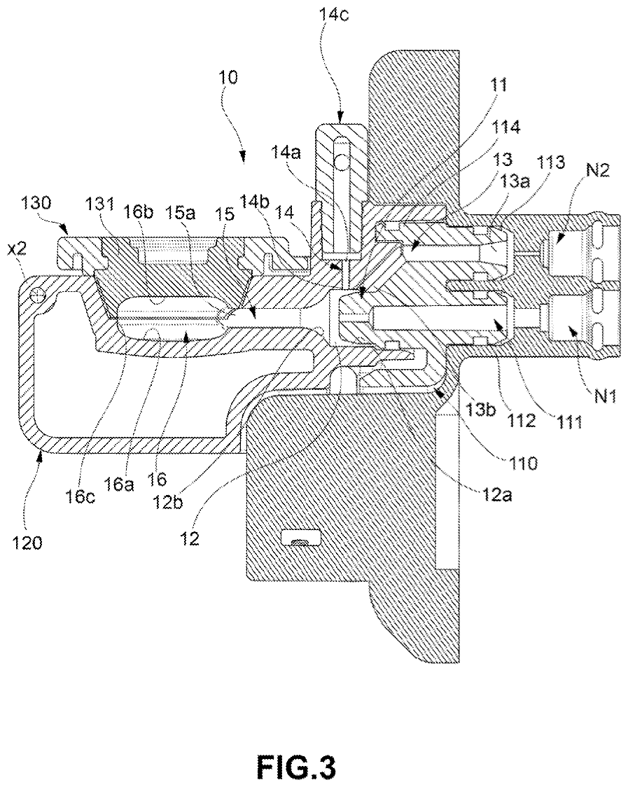

FIGS. 1 and 3 show the frothing head 10 mounted to the supply interface N, whereas FIG. 2 shows the frothing head removed from the supply interface N.

In the example shown, the supply interface N comprises a steam supply N1 and an air supply N2 which are provided to supply steam and air to the frothing head 10. The air supply N2 may be connected to an air supply system of the machine, or may be connected directly to the atmosphere of the external environment. According to alternative embodiments which are not shown, the air supply N2 may be formed on other parts of the machine M, or may not be present on the machine.

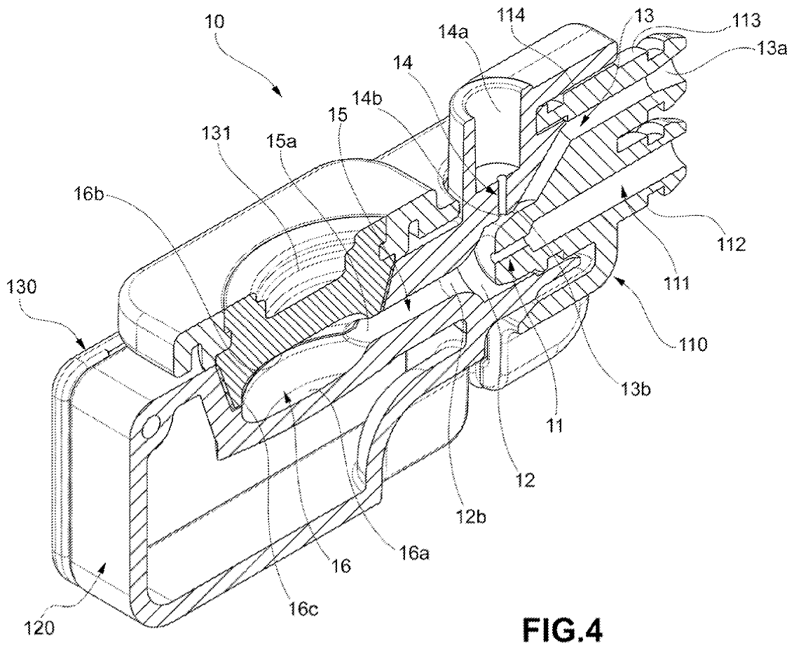

With reference to FIGS. 4 to 8, the frothing head 10 comprises a head body which may be sealingly mounted to the supply interface N. As will be explained below with reference in particular to FIGS. 6 to 8, this body may be formed by a plurality of pieces which are mounted together and arranged so as to facilitate the cleaning of the frothing head 10.

The following description will describe the ducts and the chambers formed in the head body, in the direction from the inlet for the steam, milk and air into the frothing head along separate paths, to the outlet for a mixture of steam, milk and air.

A steam supply nozzle 11 is formed in the head body, which steam supply nozzle is configured to be connected to the steam supply N1 of the supply interface N.

A mixing chamber 12 is arranged downstream of the steam supply nozzle 11. The mixing chamber 12 comprises a proximal end 12a which defines an annular gap around the steam supply nozzle 11. The mixing chamber 12 also comprises a tapered distal end 12b which forms a convergent duct.

An air suction duct 13 is also formed in the head body, which air suction duct has an inlet end 13a which is connectable to the air supply N2 and an outlet end 13b leading into the proximal end 12a of the mixing chamber 12. According to alternative embodiments, the air inlet end 13a may be connected directly to the atmosphere of the external environment.

A milk suction duct 14 is also formed in the head body, which milk suction duct has an inlet end 14a which is connectable to a milk reservoir (not shown) and an outlet end 14b leading into the proximal end 12a of the mixing chamber 12. FIGS. 1 and 3 also show a connector 14c mounted to the inlet end 14a of the milk suction duct 14, which connector is intended for connecting to the milk reservoir by means of a tube (not shown). The outlet end 13b of the air suction duct 13 is positioned upstream of the outlet end 14b of the milk suction duct 14.

The annular gap defined between the proximal end 12a of the mixing chamber 12 has a greater thickness at the outlet end 14b of the milk suction duct 14 than at the outlet end 13b of the air suction duct 13.

A restriction duct 15 is also formed in the head body, which restriction duct extends forward from the distal end 12b of the mixing chamber 12.

A frothing chamber 16 is also formed in the head body, which frothing chamber is arranged at a distal end 15a of the restriction duct 15.

Lastly, a distribution duct 17 is formed in the head body, which distribution duct extends from the frothing chamber 16. The distribution duct 17 is used to distribute the mixture obtained in the frothing head 10.

The mixing chamber 12, restriction duct 15 and frothing chamber 16 cooperate with the steam supply nozzle 11 to form a jet pump. The steam produced by the machine M may be injected into the jet pump by means of the steam supply nozzle 11, in order to generate a steam jet. The steam jet generates a negative pressure in the mixing chamber 12, which negative pressure is capable of drawing air and milk into the mixing chamber 12 through the air suction duct 13 and the milk suction duct 14, respectively. Air and milk are then mixed with the steam in the mixing chamber 12. The mixed jet then passes through the restriction duct 15 into the frothing chamber 16, and the frothing chamber homogenizes the mixture of steam, air and milk produced in the mixing chamber 12.

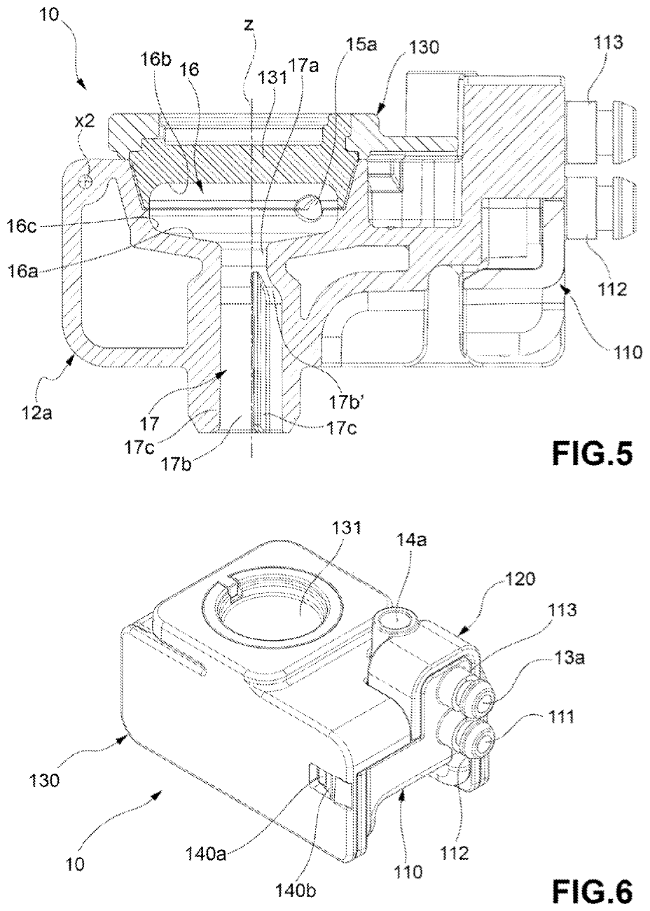

With reference in particular to FIG. 5, the frothing chamber 16 is disc-shaped and comprises a bottom surface 16a, a top surface 16b and a round side surface 16c extending between the bottom surface 16a and the top surface 16b.

The distal end 15a of the restriction duct 15 leads tangentially into the frothing chamber 16, at the side surface 16c of the frothing chamber 16 and at an intermediate height between the bottom surface 16a and the top surface 16b of the frothing chamber 16. This results in centrifugation of the mixture, which subjects the mixture to a shear stress that breaks the bubbles and makes them smaller, to the advantage of the fineness and homogeneity of the froth produced.

The distribution duct 17 extends axially from the center of the bottom surface 16a of the frothing chamber 16, and comprises an upper portion 17a and a lower portion 17b having a greater diameter than the upper portion 17a. A distribution duct 17 of this kind has a positive effect on the distribution of the froth produced by the frothing chamber 16.

The lower portion 17b of the distribution duct 17 comprises a top end 17b′ which forms a divergent duct. A plurality of axial ribs 17c is formed along the lower portion 17b of the distribution duct 17.

FIG. 5 shows a cross section along one of these axial ribs 17c. As may be seen, the distance between the ridge of this rib and the axis z of the distribution duct 17 is substantially equal to the radius of the upper portion 17a of the distribution duct 17. The ridges of the axial ribs 17c define a central lumen having a diameter substantially equal to the diameter of the upper portion 17a of the distribution duct 17. It has been found that this arrangement helps to improve the quality of the froth obtained. Nevertheless, the invention is not limited to this arrangement, and also comprises embodiments in which said central lumen has a diameter greater or less than the diameter of the upper portion 17a of the distribution duct 17.

With reference in particular to FIGS. 6 to 8, the head body comprises three body elements which are hinged to each other and may therefore rotate with respect to each other in order to facilitate cleaning operations. In an alternative embodiment that is not shown, the head body may comprise body elements made of a rigid plastics material and body elements made of a flexible elastomeric material that are connected to each other, the body elements made of elastomeric material making it possible, on account of their flexibility, to open the frothing head while maintaining a connection region between the body elements, which facilitates reassembly and cleaning of the frothing head. More in general, the head body may comprise a plurality of body elements in which the steam supply nozzle 11, the mixing chamber 12, the restriction duct 15, the frothing chamber 16 and the distribution duct 17 are formed, the body elements being constrained to each other and movable between a working position, in which the mixing chamber 12 and frothing chamber 16 are closed, and a cleaning position, in which the mixing chamber 12 and frothing chamber 16 are open. For the purposes of this invention, “constrained” is intended to mean that the body elements are permanently connected to each other, i.e. both in the working position and in the working position.

In the example shown, the head body comprises a proximal body element 110 in which the steam supply nozzle 11 is formed. A steam supply duct 111 is formed in the proximal body element 110, which steam supply duct is configured to be connected to the steam supply N1 of the supply interface N. For this purpose, in the example shown, the end upstream of the steam supply duct 111 is formed in a projection 112 configured to be sealingly inserted into a corresponding seat formed on the steam supply N1. The end downstream of the steam supply duct 111 is narrowed in order to form the steam supply nozzle 11.

The air suction duct 13 is also formed in the proximal body element 110. In the example shown, the air inlet end 13a of the air suction duct 111 is formed in a projection 113 configured to be sealingly inserted into a corresponding seat formed on the air supply N2. The air outlet end 13b of the air suction duct 13 is partly formed in the proximal body element 110 and partly formed in an intermediate body element 120.

The mixing chamber 12, the restriction duct 15, a first portion, in particular a lower portion of the frothing chamber 16, and the restriction duct 17 are formed in the intermediate body element 120.

The proximal body element 110 is hinged to the intermediate body element 120 at a hinge axis x1, which in the example shown is obtained by the pin-support coupling between a fork formed on the proximal body element 110 and a corresponding fork formed on the intermediate body element 120.

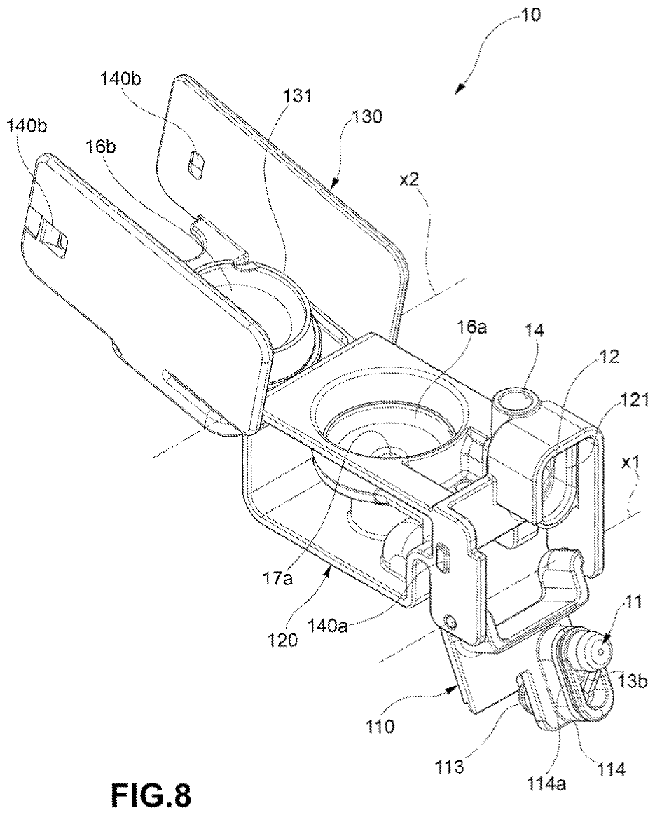

The proximal body portion 110 is rotatable, relative to the intermediate body element 120, between a working position (shown in FIGS. 1 to 7) in which the steam supply nozzle 11 is inserted into the mixing chamber 12, and a cleaning position (shown in FIG. 8) in which the steam supply nozzle 11 is extracted from the mixing chamber 12.

The steam supply nozzle 11 and part of the outlet end 13b of the air suction duct 13 are formed on a projection 114 formed on the proximal body portion 110. In the working position, this projection 114 is inserted into a corresponding seat 121 formed on the intermediate body element 120, thus inserting the steam supply nozzle 11 into the mixing chamber 12 and completing the outlet end 13b of the air suction duct 13.

In order to create a seal between the intermediate body element 120 and the proximal body element 110 in the working position, a gasket is arranged around the projection 114. This gasket is not shown in the figures, but instead a groove 114a may be seen, which groove is formed around the projection 114 in order to receive this gasket.

The head body also comprises a distal body element 130 in which a second portion of the frothing chamber 16, in particular an upper portion of this chamber, is formed. A cover 131 is sealingly mounted on the distal body element 130, which cover closes the upper portion of the frothing chamber 16 at the top thereof. This cover 131 may be made of material that is transparent to visible light, in order to allow the inside of the frothing chamber 16 to be observed and the level of cleaning of said chamber to be monitored.

This distal body element 130 is hinged to the intermediate body element 120 at a second hinge axis x2 parallel to the first hinge axis x1.

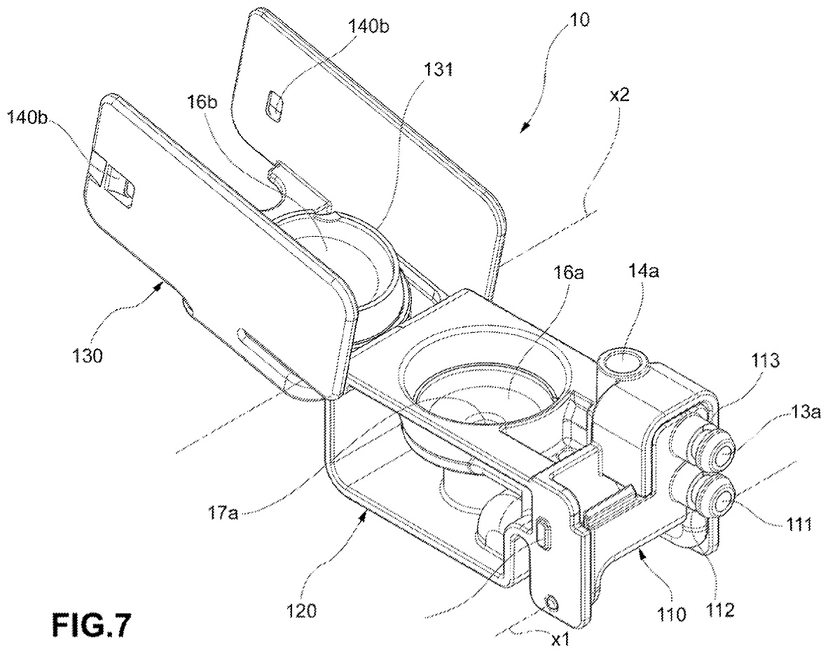

The distal body element 130 is rotatable, with respect to the intermediate body element 120, between a working position (shown in FIGS. 1 to 6) in which the lower portion and the upper portion of the frothing chamber 16 are joined to each other in order to form the frothing chamber 16, and a cleaning position (shown in FIGS. 7 and 8) in which the lower portion and the upper portion of the frothing chamber 16 are separated from each other.

Releasable locking means are provided between the distal body element 130 and the intermediate body element 120, which locking means, in the example shown, are in the form of a snap-fit coupling device. The components of this device may be seen in FIGS. 7 and 8 and are indicated by 140a and 140b. The distal body element 130 is also configured to act as a restraint on the proximal body element 110 in order to hold the proximal body element 110 in the working position.

Once the frothing head 10 has been removed from the supply interface N, the proximal body element 110 and the distal body element 130 are held in the working position on account of the coupling between the distal body element 130 and the intermediate body element 120 by means of the snap-fit coupling device 140a, 140b (FIGS. 2 and 6).

By unlocking the snap-fit coupling device 140a, 140b, it is possible to rotate the distal body element 130 in order to bring it into the cleaning position (FIG. 7). Moving the distal body element 130 thus releases the proximal body element 110, which may then be rotated into its cleaning position (FIG. 8). The frothing head is closed simply by reversing the sequence of movements described above.

The frothing head described above allows for easy cleaning of the ducts and chambers therein, as it allows easy access to practically all of its parts. Moreover, handling during cleaning operations is facilitated by the fact that the parts of the frothing head remain constrained to each other even when in the cleaning position.

Moreover, the frothing head described above has a particularly compact structure which advantageously allows it to sit alongside the coffee distribution part (not shown) of the machine M. In so doing, it is possible to make the desired preparations without having to move the cup intended to receive the beverage. Nevertheless, the invention is not limited to this specific positioning configuration of the frothing head.

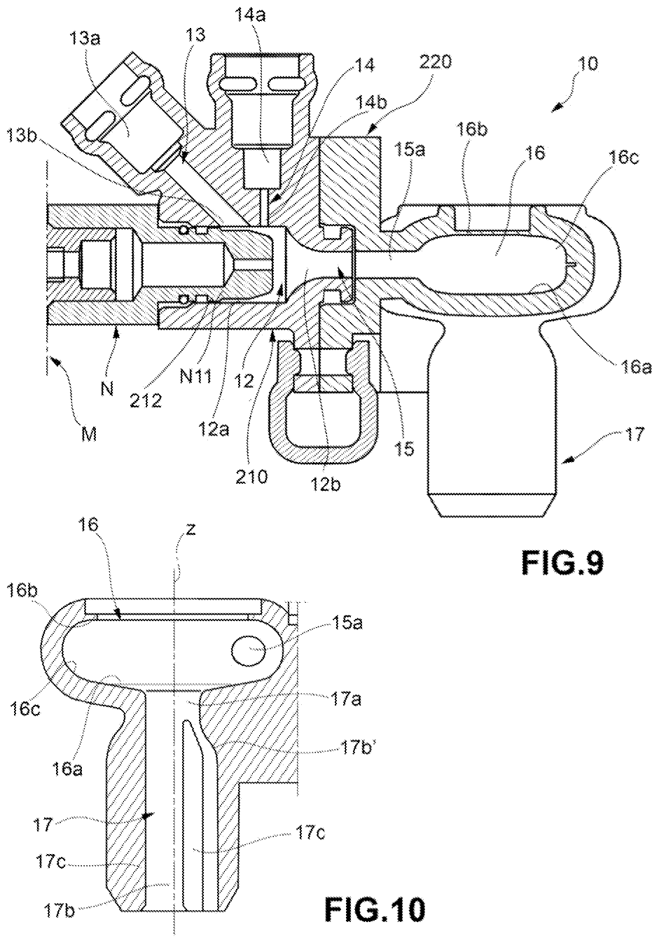

FIGS. 9 and 10 show a second embodiment of the frothing head according to the invention. Elements corresponding to those of the preceding embodiment have been assigned the same reference signs; these elements will not be described again.

In the embodiment shown in FIGS. 9 and 10, the steam supply nozzle, indicated by reference sign N11, is in the form of a component which is part of the steam supply interface N. The head body may therefore be sealingly mounted to the steam supply nozzle N11. In particular, a mounting hole 212 is formed in the head body, which mounting hole is configured to receive the steam supply nozzle N11. The mixing chamber 12 is formed so as to extend forward from the mounting hole 212. When the frothing head 10 is mounted to the interface N, the steam supply nozzle 11 is inserted into the mounting hole 212, thus closing the mixing chamber 12 on that side.

The air suction duct 13 has an inlet end 13a which may be connected to an air supply (not shown) of the kind described in relation to the preceding embodiment.

The milk suction duct 14 has an inlet end 14a which may be connected to a milk reservoir (not shown).

In the example shown in FIGS. 9 and 10, the head body comprises two body elements 210 and 220 assembled together, in which body elements the mixing chamber 12, the restriction duct 15, the frothing chamber 16 and the distribution duct 17 are formed. The detail of the frothing chamber 16 and the distribution duct 17 is shown in FIG. 10, which shows a cross section along the axis z of the distribution duct 17.

With regards to the hydraulic and pneumatic details and the operation thereof, the frothing head in FIGS. 9 and 10 is substantially identical to the preceding embodiment, for which reference is made to the description thereof.

Naturally, without prejudice to the principle of the invention, the embodiments and the details of construction may vary widely with respect to that which has been described and illustrated purely by way of non-limiting example, without thereby departing from the scope of protection of the invention as defined in the appended claims.

1. A frothing head for heating and whipping milk, comprising a head body sealingly mountable to a supply interface of a machine for the preparation of hot beverages, in said head body there being formed
a mixing chamber arranged downstream of a steam supply nozzle, the mixing chamber comprising a proximal end configured to define an annular gap around an end of the steam supply nozzle, and a convergent distal end,
a restriction duct extending forward from the distal end of the mixing chamber,
a frothing chamber arranged at a distal end of the restriction duct,
a distribution duct extending from the frothing chamber,
an air suction duct having an inlet end connectable to an air supply and an outlet end leading into the proximal end of the mixing chamber,
a milk suction duct having an inlet end connectable to a milk reservoir and an outlet end leading into the proximal end of the mixing chamber,
wherein said mixing chamber, restriction duct and frothing chamber are configured to cooperate with the steam supply nozzle to form a jet pump, in which a steam jet is capable of drawing air and milk into the mixing chamber through the air suction duct and the milk suction duct, respectively, the frothing chamber homogenizing a mixture of steam, air and milk produced in the mixing chamber,
wherein the frothing chamber is disc-shaped and comprises a bottom surface, a top surface and a round side surface extending between the bottom surface and the top surface, wherein the distal end of the restriction duct leads tangentially into the frothing chamber, at the round side surface of the frothing chamber and at an intermediate height between the bottom surface and the top surface, and
wherein the distribution duct extends axially from a center of the bottom surface of the frothing chamber, and comprises an upper portion and a lower portion having a greater diameter than the upper portion.

2. The frothing head of claim 1, wherein the lower portion of the distribution duct comprises a divergent top end.

3. The frothing head of claim 1, wherein a plurality of axial ribs is formed along the lower portion of the distribution duct.

4. The frothing head of claim 3, wherein ridges of the axial ribs define, in the distribution duct, a central lumen having a diameter substantially equal to the diameter of the upper portion of the distribution duct.

5. The frothing head of claim 1, further comprising a cover closing the frothing chamber at the top thereof.

6. The frothing head of claim 1, wherein the outlet end of the air suction duct is positioned upstream of the outlet end of the milk suction duct.

7. The frothing head of claim 6, wherein said annular gap has a greater thickness at the outlet end of the milk suction duct than at the outlet end of the air suction duct.

8. The frothing head of claim 1, wherein the head body comprises the steam supply nozzle which is configured to be connected to a steam supply of the supply interface.

9. The frothing head of claim 1, wherein the head body comprises a plurality of body elements in which the mixing chamber, the restriction duct, the frothing chamber and the distribution duct are formed, said body elements being constrained to each other and movable between a working position, in which said mixing chamber and frothing chamber are closed, and a cleaning position, in which said mixing chamber and frothing chamber are open.

10. The frothing head of claim 1, wherein the head body comprises a proximal body element in which the steam supply nozzle is formed, an intermediate body element in which the mixing chamber, the restriction duct, a first portion of the frothing chamber and the distribution duct are formed, and a distal body element in which a second portion of the frothing chamber is formed.

11. The frothing head of claim 10, wherein the proximal body element is hinged to the intermediate body element, and is rotatable between a working position in which the steam supply nozzle is inserted into the mixing chamber, and a cleaning position in which the steam supply nozzle is extracted from the mixing chamber.

12. The frothing head of claim 10, wherein the distal body element is hinged to the intermediate body element, and is rotatable between a working position in which said first and second portions of the frothing chamber are joined to each other to form the frothing chamber, and a cleaning position in which said first and second portions of the frothing chamber are separated from each other.

13. The frothing head of claim 1, wherein the supply interface comprises the steam supply nozzle, the head body being sealingly mountable to the steam supply nozzle, wherein a mounting hole is formed in said head body, the mounting hole being configured to receive the steam supply nozzle, and said mixing chamber extending forward from the mounting hole.

14. The frothing head of claim 5, wherein said cover is made of material transparent to visible light.
